(19) United States
(12) Patent Application Publication
(10) Pub. No.: US 2017/0298652 A1
(43) Pub. Date: Oct. 19, 2017

(54) FIX POSISTION DEVICE FOR CASEMENT LATCH

(71) Applicant: Wan Lai Liau, New Taipei (TW)

(72) Inventor: Wan Lai Liau, New Taipei (TW)

(21) Appl. No.: 15/131,103

(22) Filed: Apr. 18, 2016

(51) Int. Cl. E05B 15/00; E05C 3/16

(52) U.S. Cl. CPC E05B 15/006; E05B 15/008; E05C 3/16

(57) ABSTRACT

A fix position device for casement latch includes a housing including a cavity, a through hole, first and second limit members, a hole having one end communicating with the cavity and the other end formed with threads, a spring biased steel ball in both the hole and the cavity, and an adjustment screw secured to the threads; a bolt including a cylindrical axis partially in the through hole, a channel having a square section and formed through the axis, two recesses on a periphery of the axis, and an engagement member at the other end; a cover plate including a central hole with the axis partially disposed therein; a face plate including an intermediate slit with the engagement member passing through; and a handle assembly including a peg member having a square section projecting through the channel, and a lever having one end co-rotated with the peg member.

### BACKGROUND OF THE INVENTION

### 1. Field of the Invention

The invention relates to casement window locks and more particularly to a lock latch for a casement window having improved characteristics in the fix position.

### 2. Description of Related Art

A conventional lock latch for a casement is shown in FIGS. 9, 10 and 11 and comprises a housing 1, a bolt 2 rotatably mounted in the housing 1, a cover plate 3 and a face plate 4. An individual may clockwise rotate the bolt 2 to insert an engagement member 22 into the hole 43 of the face plate 4 to lock the casement or counterclockwise rotate the bolt 2 to remove the engagement member 22 out of the hole 43 to unlock the casement.

The drawbacks of the conventional lock latch for the casement are detailed below. The lock latch may be jammed or loosed after a period of time of use because the bolt 2 is not pressed by spring member. Moreover, the bolt 2 may fall to compromise the unlocked state due to its weight.

For eliminating above drawbacks of the conventional lock latch for the casement, a great number of patent documents are disclosed. For example, Taiwan Utility Model No. M399895 discloses a hinge type lock latch for a casement and is characterized in that an elastic member is provided to urge against an axis, and an inner surface of a recess in the housing may act to stop a rotation of the axis when the axis has rotated to a desired position. As a result, the bolt is locked. The inventor's Taiwan Patent Application No. 104113252, China Patent Application No. 2015102223553.8, and U.S. patent application Ser. No. 14/726,705 all disclose a characteristic of employing two elastic members to urge against and stop a further rotation of an axis when it has rotated to a desired locking position of the bolt.

While products based on the inventor's above patent applications enjoy its success in the market, continuing improvements to eliminate problems including the elastic members being liable to breakage and elastic force adjustment of the elastic members being not available are constantly being sought.

### SUMMARY OF THE INVENTION

It is therefore one object of the invention to provide a lock latch for a casement window comprising a housing having a flat first edge and a curved second edge opposing the first edge, the housing including a cavity open to the flat first edge, a through hole through the cavity, a raised first limit member above the through hole, a raised second limit member under the through hole, a hole having one end communicating with the cavity and the other end formed with threads, a steel ball at one end of the hole, a torsion spring in the hole, and an adjustment screw secured to the threads to compress the torsion spring which in turn urges the steel ball to partially project into the cavity; a bolt including a cylindrical axis at one end, the cylindrical axis being partially disposed in the through hole, a channel having a substantially square section and formed through the cylindrical axis, two spaced recesses on a periphery of the cylindrical axis, and a bent engagement member formed with the other end; a cover plate shaped corresponding to the housing and including a central hole with the cylindrical axis partially disposed therein; an elongated face plate including an intermediate slit with the engagement member passing through; and a handle assembly including a rectangular plate, a peg member having a square section projecting out of an inner surface of the plate, the peg member being inserted through the channel, and a lever having one end co-rotated with the peg member; wherein in a locked position, the steel ball is complimentarily disposed in one of the recesses, and the engagement member is stopped by the first limit member; wherein a clockwise turning of the lever rotates the bolt to move the steel ball from one recess by clearing one recess to the other recess in an unlocked position by entering the other recess with the torsion spring being compressed and then expanded; and wherein in the unlocked position, the engagement member is stopped by the second limit member.

The above and other objects, features and advantages of the invention will become apparent from the following detailed description taken with the accompanying drawings.

### BRIEF DESCRIPTION OF THE DRAWINGS

FIG. 1 is an exploded view of a lock latch for a casement according to the invention;

FIG. 2 is a front view of the assembled lock latch of FIG. 1 showing a locked position;

FIG. 3 is a sectional view taken along line 3-3 of FIG. 2;

FIG. 4 is a front view of the assembled lock latch of FIG. 1 showing an unlocked position;

FIG. 5 is a sectional view taken along line 5-5 of FIG. 4;

FIG. 6 is an exploded view of the lock latch for the casement according to the invention with a handle assembly added thereto;

FIG. 7 is a front view of the assembled lock latch and handle assembly of FIG. 6;

FIG. 8 is a sectional view taken along line 8-8 of FIG. 7;

FIG. 9 is an exploded view of a conventional lock latch for a casement;

FIG. 10 is a front view of the assembled lock latch of FIG. 9; and

FIG. 11 is a sectional view taken along line 11-11 of FIG. 10.

### DETAILED DESCRIPTION OF THE INVENTION

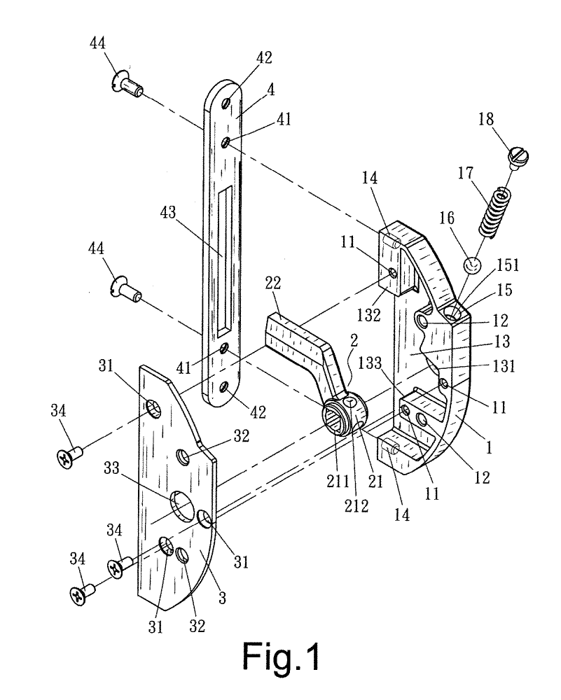

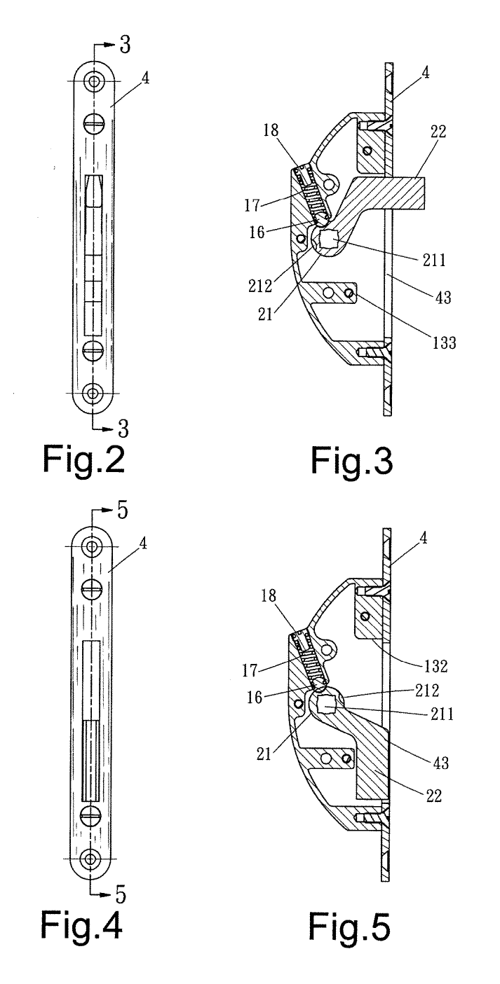

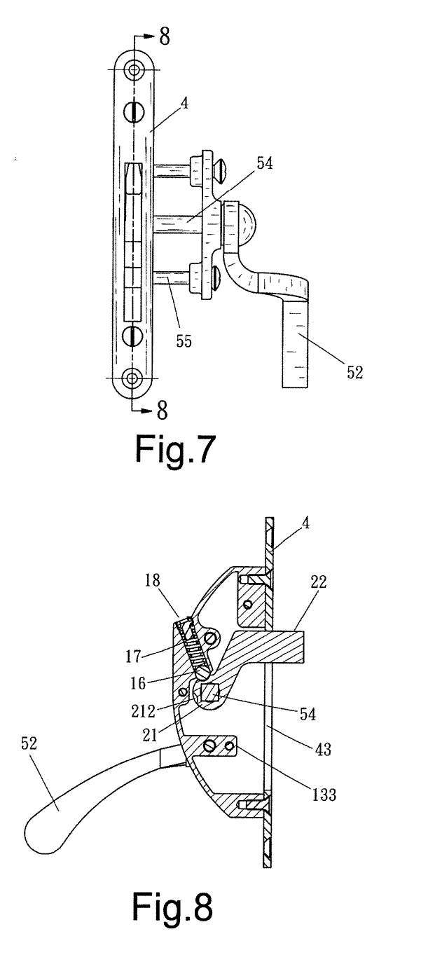

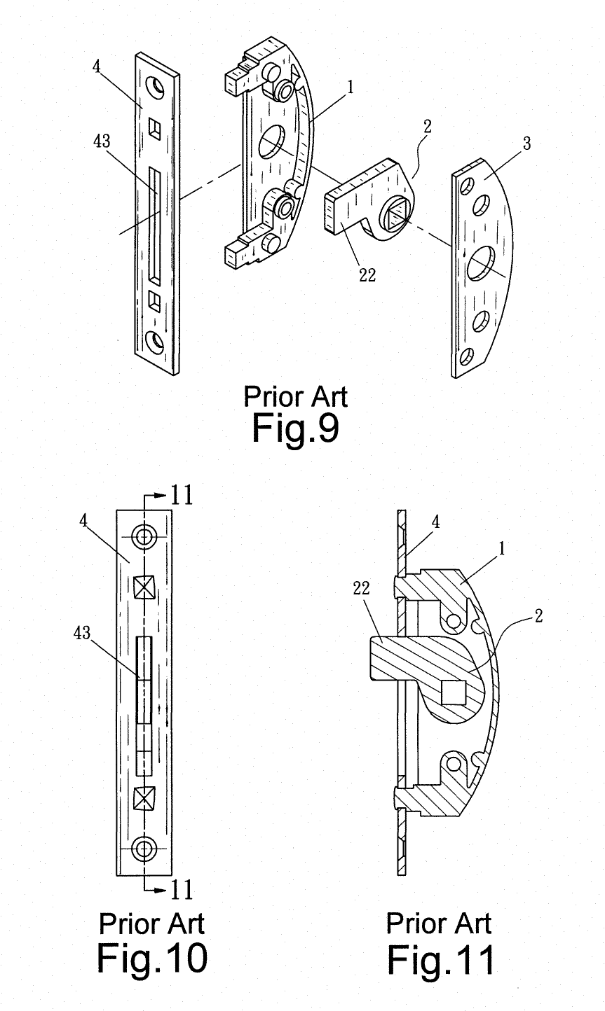

Referring to FIGS. 1 to 8, a lock latch for a casement window in accordance with the invention comprises the following components as discussed in detail below.

A metal housing 1 has a flat first edge and a curved second edge opposing the first edge. The housing 1 includes three first threaded holes 11; two second threaded holes 12; a cavity 13 open to the flat first edge and having a through hole 131, a raised first limit member 132 above the through hole 131, and a raised second limit member 133 under the through hole 131; two threaded apertures 14 at both end of the flat first edge; a hole 15 having one end communicating with the cavity 13 and the other end formed with threads 151; a steel ball 16 at one end of the hole 15; a torsion spring 17 in the hole 15; and an adjustment screw 18 secured to the threads 151 to compress the torsion spring 17 which in turn urges the steel ball 16 so that the steel ball 16 may partially project into the cavity 13.

A bolt 2 includes a cylindrical axis 21 at one end, the cylindrical axis 21 being partially disposed in the through hole 131, a channel 211 having a substantially square section and formed through the cylindrical axis 21, two spaced recesses 212 on a periphery of the cylindrical axis 21, and a bent engagement member 22 formed with the other end.

A cover plate 3 is shaped corresponding to the housing 1 and includes two first holes 31; two second holes 32; a central hole 33 with the cylindrical axis 21 partially disposed therein; and three screws 34 each driven through the first hole 31 into the first threaded hole 11 to fasten the cover plate 3 and the housing 1 together. An elongated face plate 4 includes an intermediate slit 43 with the engagement member 22 passing through, two first holes 42 at two ends respectively, two second holes 41 each between one first hole 42 and the slit 43 or between the other first hole 42 and the slit 43, and two screws 44 driven through the second holes 41 into the threaded apertures 14 respectively to fasten the face plate 4 and the housing 1 together.

A handle assembly 5 includes a rectangular plate 51, two through holes 53 at two ends of the plate 51 respectively, a peg member 54 having a square section projecting out of an inner surface of the plate 51, the peg member 54 inserted through the channel 211 to be held in place, a lever 52 having one end co-rotated with the peg member 54, and two screws 55 driven through the through holes 53 and the second holes 32 into the second threaded holes 12 to fasten the handle assembly 5, the cover plate 3 and the housing 1 together.

In a locked position of the lock latch (see FIGS. 3 and 4), the steel ball 16 is complimentarily disposed in one of the recesses 212, and the engagement member 22 is stopped by the first limit member 132.

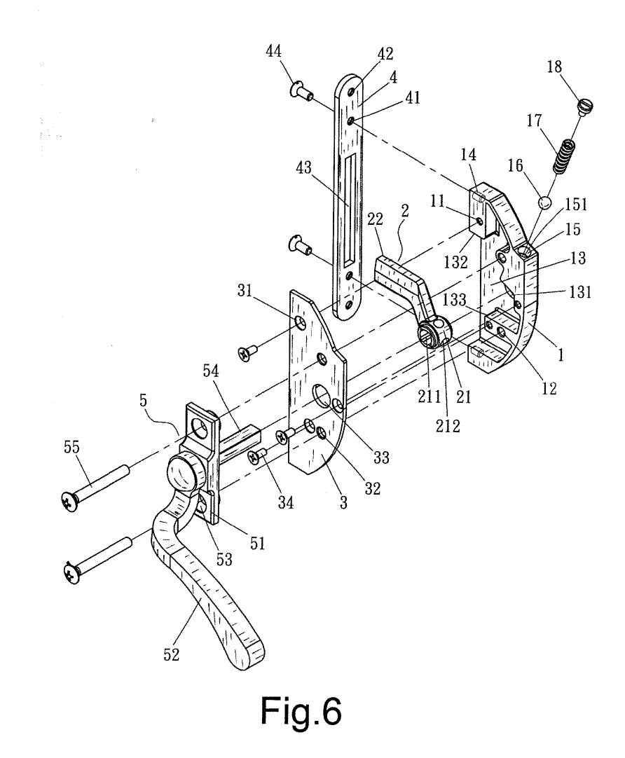

An unlocking operation of the invention is discussed below by referring to FIGS. 3 to 6. An operator may clockwise turn the lever 52 to rotate the bolt 3. And in turn, the steel ball 16 moves from one recess 212 in the locked position by clearing one recess 212 (see FIGS. 3 and 4) to the other recess 212 in the unlocked position by entering the other recess 212 (see FIGS. 5 and 6) with the torsion spring 17 being compressed and then expanded. In locked position, the steel ball 16 is complimentarily disposed in the other recess 212, and the engagement member 22 is stopped by the second limit member 133.

A counterclockwise rotation of the lever 52 can lock the lock latch. Compression of the torsion spring 17 can be adjusted by inserting the tip of a slot screw drive into the head of the adjustment screw 18 to clockwise or counterclockwise turning the adjustment screw 18. As a result, friction of the steel ball 16 in the recess 212 can be adjusted.

While the invention has been described in terms of preferred embodiments, those skilled in the art will recognize that the invention can be practiced with modifications within the spirit and scope of the appended claims.

1. A fix position device for casement latch comprising:
a housing (1) having a flat first edge and a curved second edge opposing the flat first edge, the housing (1) including a cavity (13) open to the flat first edge, a through hole (131) through the cavity (13), a raised first limit member (132) above the through hole (131), a raised second limit member (133) under the through hole (131), a hole (15) having a first end communicating with the cavity (13) and a second end formed with threads (151), a steel ball (16) at the first end of the hole (15), compression spring (17) in the hole (15), and an adjustment screw (18) secured to the threads (151) to compress the compression spring (17) which in turn urges the steel ball (16) to partially project into the cavity (13);
a bolt (2) including a cylindrical axis (21) at a first end, the cylindrical axis (21) being partially disposed in the through hole (131), a channel (211) having a square section and formed through the cylindrical axis (21), two spaced recesses (212) on a periphery of the cylindrical axis (21), and a bent engagement member (22) formed with a second end;
a cover plate (3) shaped corresponding to the housing (1) and including a central hole (33) with the cylindrical axis (21) partially disposed therein;
an elongated face plate (4) including an intermediate slit (43) with the bent engagement member (22) passing through; and
a handle assembly (5) including a rectangular plate (51), a peg member (54) having a square section projecting out of an inner surface of the rectangular plate (51) and through the channel (211), and a lever (52) having one end co-rotated with the peg member (54);
wherein in a locked position, the steel ball (16) is complimentarily disposed in a first of the two spaced recesses under adjustable compression (212), and the bent engagement member (22) is stopped by the raised first limit member (132);
wherein a turning of the lever (52) in a first direction rotates the bolt (3) to move the steel ball (16) from the first of the two spaced recesses (212) by clearing the first of the two spaced recesses to a second of the two spaced recesses (212) in an unlocked position by entering the second of the two spaced recesses (212) under adjustable compression with the compression spring (17) being compressed and then expanded; and
wherein in the unlocked position, the bent engagement member (22) is stopped by the raised second limit member (133).

2. The fix position device for casement latch of claim 1, wherein compression of the compression spring (17) is configured to adjust by clockwise or counterclockwise turning the adjustment screw (18), thereby adjusting friction of the steel ball (16) in either of the two spaced recesses (212).

3. The fix position device for casement latch of claim 1, wherein the housing and the cover plate as connected by first screws (34) and the face plate and housing as connected by second screws (44) define the cavity as an enclosed cavity.

4. The fix position device for casement latch of claim 1, wherein the lever of the handle assembly extends outwardly from the cover plate.
